(19) United States
(12) Patent Application Publication
(10) Pub. No.: US 2019/0037772 A1
(43) Pub. Date: Feb. 7, 2019

(54) HYDRAULIC OR ELECTRIC DE-THATCHER AND AERATOR POWER LIFT ATTACHMENTS

(71) Applicant: Lynn D. Jurrens, St. Michael, MN (US)

(72) Inventor: Lynn D. Jurrens, St. Michael, MN (US)

(21) Appl. No.: 16/050,398

(22) Filed: Jul. 31, 2018

Related U.S. Application Data
(60) Provisional application No. 62/539,633, filed on Aug. 1, 2017.
(60) Provisional application No. 62/539,641, filed on Aug. 1, 2017.

(51) Int. Cl. A01D 87/00; A01B 63/111; A01B 63/102; B60D 1/46

(52) U.S. Cl. CPC A01D 87/0069; A01B 63/1117; B62D 49/02; B60D 1/465; A01B 63/102

(57) ABSTRACT

A hydraulic or electric de-thatcher power lift assembly attachment that provides control while de-thatching because it is stable and efficient and can be lifted with ease at any time when dealing with difficult terrain. In an example embodiment, the hydraulic version fits hydraulic equipped tractors. In an alternative embodiment, the device may be used with an electric motor from the tractor, or can have its own dedicated battery for power. A hydraulic or electric lift assembly is also provided for a lawn aerator. The various attachments are designed to replace the standard manual lift lever on standard aerators. The attachments can be used on tractors that have hydraulics built into the tractor or on tractors with an electric motor.

This application claims priority to and the benefit of U.S. Provisional Application having Ser. No. 62/539,633 and filed on Aug. 1, 2017, entitled HYDRAULIC OR ELECTRIC DE-THATCHER POWER LIFT ATTACHMENT; and U.S. Provisional Application having Ser. No. 62/539,641 and filed on Aug. 1, 2017, entitled AERATOR HYDRAULIC OR ELECTRIC LIFT ATTACHMENT, the contents of which are incorporated by reference in their entireties.

### FIELD OF THE INVENTION

The invention relates generally to a lift attachment for a tractor.

### BACKGROUND

Currently there are a number of solutions for de-thatching a lawn. Some of these solutions attempt to use a standard push mower style de-thatcher, but these solutions fail to meet the needs of the market because a push de-thatcher is labor intensive and tiring. Other solutions attempt to use a standard de-thatcher attachment for a riding lawn mower, but these solutions are similarly unable to meet the needs of the market because the de-thatcher is a stable unit with no control of lifting should it need to be raised over certain terrain. Still other solutions seek to use de-thatcher attachments that can be raised or lowered, but these solutions also fail to meet market needs because the lifting mechanism is controlled manually and usually the mower needs to be stopped before the device can be lifted or lowered.

Similarly, there are a number of solutions for tackling the chore of lawn aeration. Some of these solutions attempt to sell aeration lawn shoes, but these solutions fail to meet the needs of the market because it can take a very long time to complete a yard. Other solutions attempt to sell push roller aeration devices, but these solutions are similarly unable to meet the needs of the market because there is less control over the push roller device's maneuverability. Still other solutions seek to utilize a traditional riding mower aeration attachment, but these solutions also fail to meet market needs because a manual lift is required to raise the aeration attachment.

### SUMMARY OF THE INVENTION

It would be advantageous to have an apparatus, as described herein, that is a heavy-duty de-thatching assembly attachment. Furthermore, it would also be advantageous to have an apparatus, as described herein, that can be lifted while the tractor is still turned on or running. Still further, it would be advantageous to have an apparatus, as described herein, which is offered in a hydraulic version and an electric version. Therefore, there currently exists a need in the market for an apparatus, as described herein, that is a de-thatching assembly attachment constructed of solid tube steel and strap iron that can be lifted in use by a hydraulic lifting mechanism or electric motor depending on the tractor's capability.

The various embodiments of the invention advantageously fill the aforementioned deficiencies by providing a hydraulic de-thatcher power lift assembly attachment. The apparatus provides stability and is efficient due to a hitch insert and double chain attachment points. The apparatus may have a hydraulic version and an electric version. Among other things, it is an advantage of the invention to provide a hydraulic de-thatcher power lift assembly attachment that does not suffer from any of the problems or deficiencies associated with prior solutions.

In one example embodiment, there is provided lifting system configured for attachment to a lawnmower or a tractor, the system including a brace frame configured with a coupler member for coupling the brace frame to the lawnmower or tractor, the brace frame including a cantilevering arm member located on the brace frame above the coupler member and configured to cantilever vertically up and down upon actuation, the cantilevering arm member having at least one blade arm protruding laterally away from the brace frame, wherein the at least one blade arm includes an attachment member at a distal end for attaching to a lawn or farm accessory. The lifting system also includes a lift assembly having a distal portion coupled to a lower portion of the brace frame and a proximal end coupled to the at least one blade arm, the lifting assembly configured to lift the cantilever arm up and down upon actuation, wherein the at least one blade arm with the attachment member raises and lowers the lawn or farm accessory upon actuation of the lifting assembly.

In a related embodiment, the lift assembly is selected from either a hydraulic arrangement or an electric motor and lever linkage arrangement.

It would be advantageous to have an apparatus, as described herein that is a hydraulic lift assembly attachment for an aeration device. Furthermore, it would be advantageous to have a lift apparatus, as described herein, that is offered in a hydraulic version and an electric version. Therefore, there currently exists a need in the market for an apparatus that is an attachment constructed of solid tube steel and strap iron, of which can lift an attachment by a hydraulic lifting mechanism or electric motor depending on tractor's capability.

The invention advantageously fills the aforementioned deficiencies by providing a hydraulic lift assembly attachment for a lawn aerator. In one example embodiment, the invention is a hydraulic lift assembly attachment for a trailer-pulled or trailer-assisted aerator device. In one example embodiment, the apparatus has tube steel and strap iron construction and/or can be constructed of durable molded plastic. In an alternative embodiment, the apparatus may have an electric motor option.

Among other things, it is an advantage of the invention to provide a hydraulic lift attachment for a lawn aerator that does not suffer from any of the problems or deficiencies associated with prior solutions. It is still further an advantage of the invention to provide a power option instead of manual controls. Still further, the apparatus has the ability to allow the user to easily avoid obstacles while precisely aerating the exact locations needed.

In one example embodiment, there is provided a lifting system for an aerator assembly for attachment to a lawnmower or a tractor, the system comprising: a brace frame having at least one lever linkage coupled to a lower portion of the base frame and a longitudinal frame above the linkage and extending laterally from the brace frame, the longitudinal frame configured to support an aerator assembly thereon with the longitudinal frame including a coupler member at a distal end for coupling the brace frame to the lawnmower or tractor, the brace frame also including a cantilevering arm member with a proximal end coupled to proximal end of the longitudinal frame, wherein the lever linkage becomes straight when the cantilevering arm is actuated to cantilever vertically up. The lift system further includes a lift assembly coupled to a distal portion of the cantilevering arm, the lifting assembly configured to lift the cantilever arm up and down upon actuation, wherein the cantilevering arm raises and lowers the aerator assembly upon actuation of the lifting assembly. The lift system also includes a shaft with wheels assembly attached, the shaft having a proximal end of the lift assembly attached to the shaft at least at one point between the wheels, the brace frame attached via the at least one lever linkage to the shaft-wheels assembly, wherein the shaft-wheels assembly lifts the aerator accessory as the lift assembly causes the wheels to move toward the aerator, thereby lifting the aerator accessory. In a related embodiment, the lift assembly is selected from either a hydraulic arrangement or an electric motor and lever linkage arrangement.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 illustrates an example embodiment of the lift for a de-thatcher assembly attachment in a hydraulic mode as described herein; and

FIG. 2 illustrates an example embodiment of a lift device with an electric motor as described herein.

FIGS. 3 and 4 illustrate perspective and side views of an example embodiment of a lift assembly attachment for an aerator according to the teachings herein.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

In one example embodiment, the invention is directed to be a hydraulic de-thatcher power lift assembly attachment. In this example embodiment, the invention may be constructed of solid tube steel and strap iron. The hydraulic de-thatcher power lift attachment provides control while dethatching because it is stable, secure and efficient. The de-thatcher assembly may also include a hitch insert and double chain attachment points. In an example embodiment, the hydraulic version fits hydraulic equipped tractors. In an alternative embodiment, the de-thatcher assembly is used or operated with electric motor tractor.

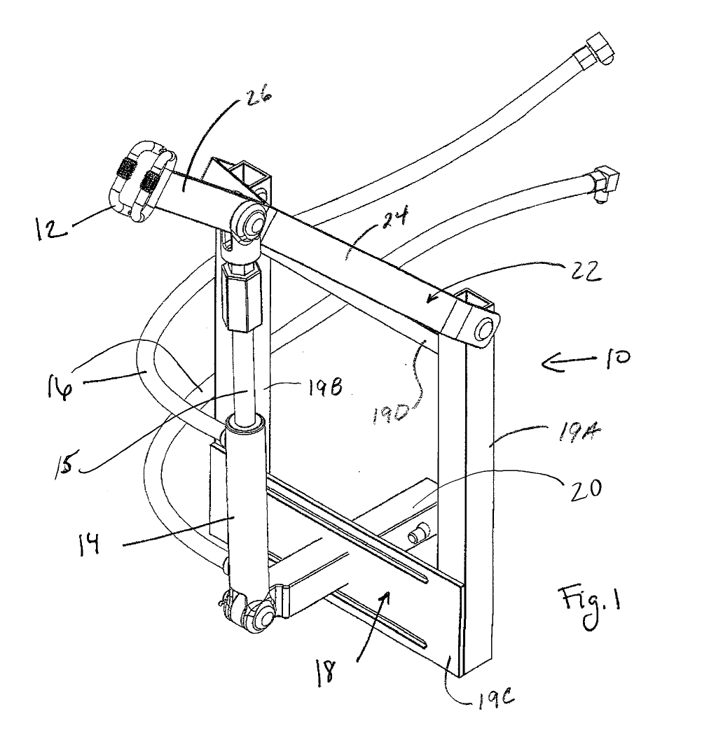

Referring to the figures, FIG. 1 illustrates an example embodiment of a lift device or assembly 10. Lift device or assembly 10 includes chain attachment points 12, a hydraulic cylinder 14, a hydraulic shaft or arm 15, a set of hydraulic tubes 16, and a brace frame 18. Brace frame 18 includes two side members or portions 19A and 19B and an upper and lower portions or bars 19C and 19D. Hydraulic tubes 16 are connected to hydraulic cylinder 14, which lifts and lowers cantilever 22, which includes a cantilever arm 24 and a blade arm 26, blade arm 26 being attached to a de-thatcher at attachment member 12 (which are rings or loops but can optionally be eyelets, hooks or clamps). Upon actuation by the user, hydraulic cylinder 14 deploys shaft 15 which pushes up blade arm 26, thereby pushing up the de-thatcher via attachment member 12. Hitch or coupler member 20 serves to couple lift assembly 10 to the lawn mower or tractor.

In use, when a user wants to lift or lower lift device 10, the user presses a button that controls hydraulic cylinder 14 via hydraulic tubes 16. This allows the user to control when the de-thatcher (or aerator) is lifted and lowered while user is driving the tractor or using the lawnmower. In an alternative embodiment, lift device or assembly 10 may connected to other attachments such as plows, buckets, or snow blowers. It is preferable to use the hydraulic approach described herein when using landscaping, farming or snow clearing accessories due to the weight of the accessories as the hydraulic component is configurable to lift items of increased weight, depending on the application.

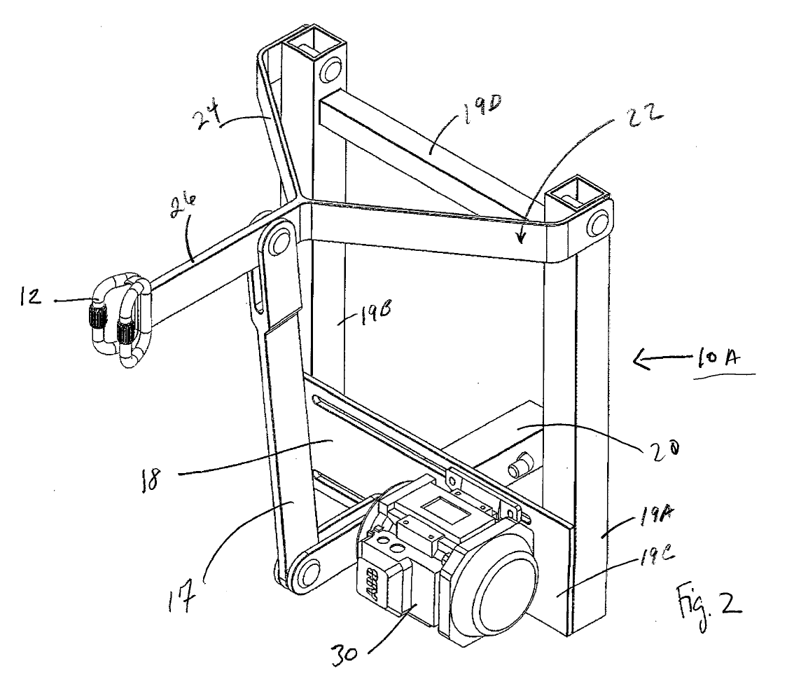

In still a further embodiment, lift device 10 may be controlled by an electric motor (from the tractor or by an independent battery mounted along the motor). FIG. 2 illustrates lift device or assembly 10A including an electric motor 30 coupled to a lever linkage 17. Upon actuation, electric motor 30 is capable of lifting and lowering a de-thatcher by moving up or straightening out linkage 17 which in turns lifts blade arm 26. It is preferably to keep the landscaping and farming accessories being used in the electric motor configuration to items under 100 pounds due to the structural limitations of the motor and lever linkage(s).

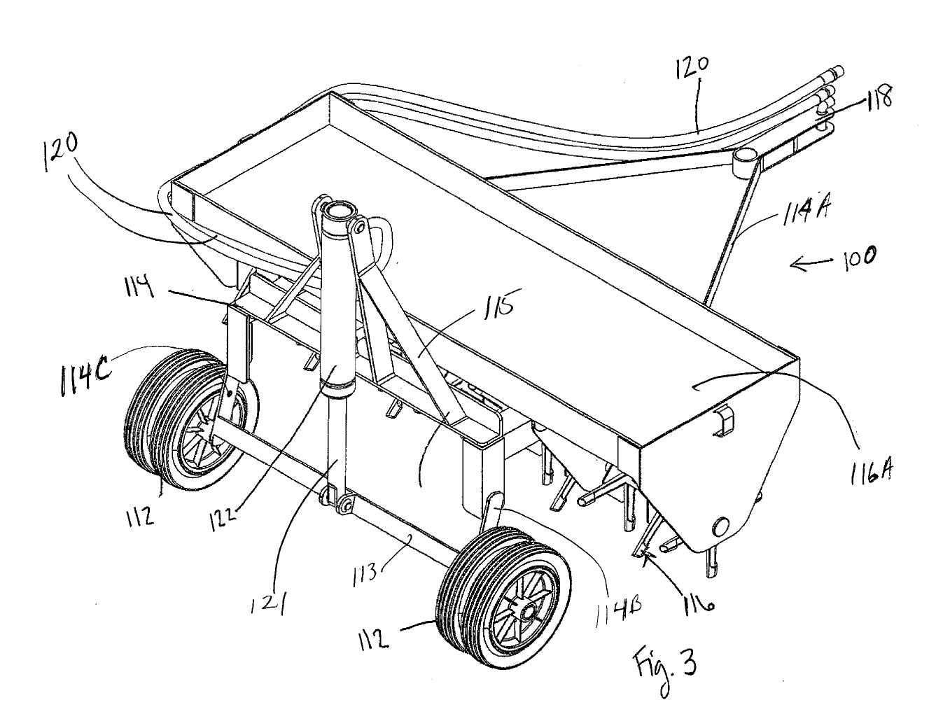

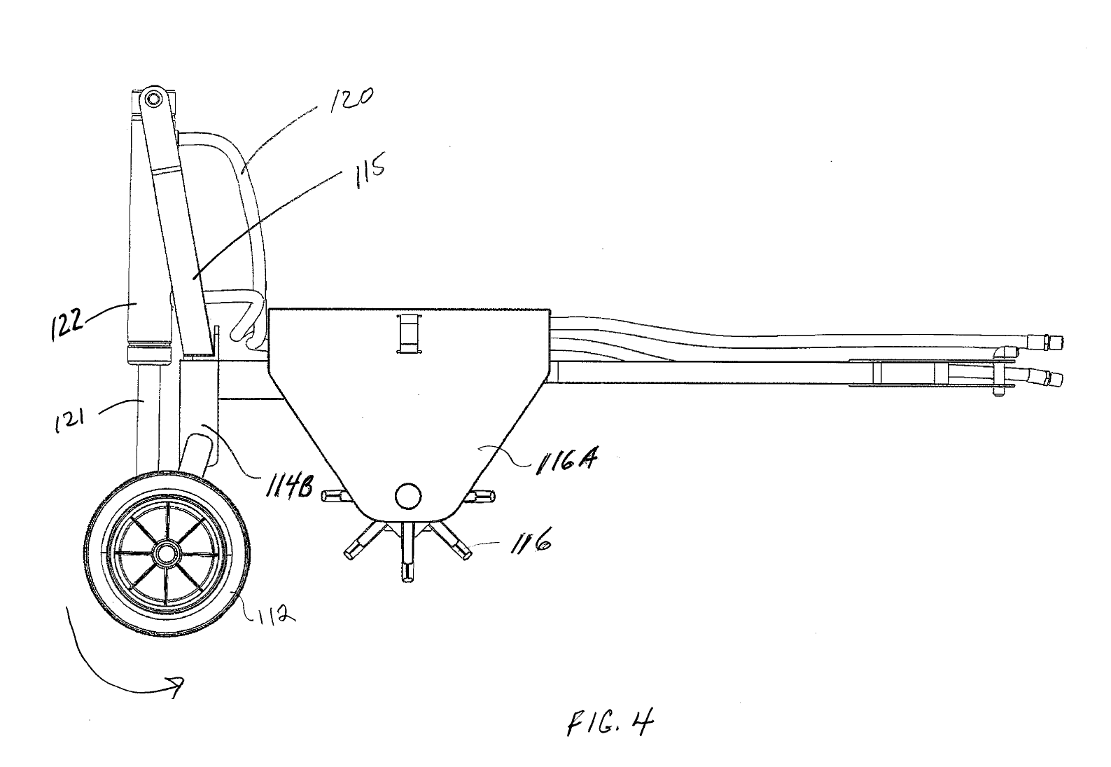

Referring now to FIGS. 3 and 4, there is illustrated at least one embodiment of various potential embodiments of the invention for a hydraulic or electric lift assembly attachment 100 for a lawn aerator. The invention includes attachments designed to replace the standard manual lift lever on standard aerators. The attachments can be used on tractors that have hydraulics built into the tractor or on tractors with an electric motor or tractors or motorized vehicles that can use an electric motor with battery power provided by the tractor or with a dedicated battery mounted on the lift assembly frame. The lift assemblies are constructed with tube steel and strap iron and/or can be constructed of durable molded plastic or other reliable and durable materials. In a related embodiment, the hydraulic or electric lift assembly for an accessory such as an aerator is configurable to be a garden seeder (or fertilizer or pesticide/herbicide spreader, etc.) that is activated when it is in contact with the ground and deactivates once it is off the ground.

Referring to the figures, FIGS. 3 and 4 illustrate an example embodiment of a lift system or apparatus 100, with the lift system in the extended or lifted or raised view in FIG. 4. Lift system 100 includes a set of wheels 112 mounted on a shaft 113, a brace frame 114 (which includes a longitudinal frame 114A and a lever linkage 114B and third linkage 114C) with a cantilevering arm 115, an aerator assembly 116 (example but not limited to such accessory), a hinge or hitch attachment 118, a set of hydraulic tubes 120 to be coupled to the tractor at one end and coupled to a hydraulic cylinder 122 (with a cylinder shaft or rod 121) at the other end. Hydraulic tubes 120 actuate hydraulic cylinder 122 so as to lift and lower aerator 116. In this example, aerator 116 includes a pan 116A for placing additional weight on the aerator to improve its performance. In an alternative embodiment, lift device or assembly 100 includes other attachments such as mowers, plow, seeder, trailer, grader, or auger.

In still a further embodiment, although not shown, lift device 100 (substitutes a lever linkage and motor for the hydraulic cylinder 122) is controlled by an electric motor that includes an additional lever linkage to move cantilever arm 115 up and down, thereby moving wheels 112 towards aerator 116 and lifting it off the ground.

With reference to FIG. 4, in use, when a user wants to lift or lower lift device 100, the user presses a button (either on the unit or connected back to the tractor) that controls hydraulic cylinder 122 which in turn extends the cylinder thereby moving wheels 112 towards the aerator (see arrow) and lifting the aerator. This allows user to control when aerator 116 is lifted and lowered while user is driving the tractor.

Hinge or hitch attachment 118 includes ball-and-socket (not illustrated) for attachment to tractors. Hinge attachment 118 also includes placement or track to run hydraulic tubes 120 to the tractor for power and control.

The following patents are incorporated by reference in their entireties: U.S. Pat. Nos. 3,990,723; 4,139,063; and 4,345,871.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A lifting system configured for attachment to a lawnmower or a tractor, the system comprising:
a brace frame configured with a coupler member for coupling the brace frame to the lawnmower or tractor, the brace frame including a cantilevering arm member located on the brace frame above the coupler member and configured to cantilever vertically up and down upon actuation, the cantilevering arm member having at least one blade arm protruding laterally away from the brace frame, wherein the at least one blade arm includes an attachment member at a distal end for attaching to a lawn or farm accessory; and
a lift assembly having a distal portion coupled to a lower portion of the brace frame and a proximal end coupled to the at least one blade arm, the lifting assembly configured to lift the cantilever arm up and down upon actuation, wherein the at least one blade arm with the attachment member raises and lowers the lawn or farm accessory upon actuation of the lifting assembly.

2. The lifting system of claim 1, wherein the lift assembly comprises a hydraulic shaft or arm disposed within a hydraulic cylinder and a set of hydraulic tubes for controlling a vertical movement of the hydraulic shaft.

3. The lifting system of claim 1, wherein the lift assembly comprises a lever linkage and an electric motor combination for actuating the cantilever arm, wherein a proximal portion of the lever linkage is coupled to the blade arm and a distal portion of the lever linkage is attached to the motor, the motor being mounted to the lower portion of the brace frame.

4. The lifting system of claim 1, wherein the lawn or farm accessory is one of a de-thatcher mechanism and an aerator mechanism.

5. The lifting system of claim 1, wherein the attachment member on the cantilever arm is one of a metal loop or an eyelet, a clamp, and a hook.

6. The lifting system of claim 1, wherein the lawn or farm accessory is one of a plow, a bucket, and a snow blower.

7. The lifting system of claim 1 wherein the coupler member includes a hitch device to connect the lifting system between the lawn accessory and the tractor or a motorized vehicle.

8. A lifting system for an aerator assembly for attachment to a lawnmower or a tractor, the system comprising:
a brace frame having at least one lever linkage coupled to a lower portion of the base frame and a longitudinal frame above the linkage and extending laterally from the brace frame, the longitudinal frame configured to support an aerator assembly thereon with the longitudinal frame including a coupler member at a distal end for coupling the brace frame to the lawnmower or tractor, the brace frame also including a cantilevering arm member with a proximal end coupled to proximal end of the longitudinal frame, wherein the lever linkage becomes straight when the cantilevering arm is actuated to cantilever vertically up;
a lift assembly coupled to a distal portion of the cantilevering arm, the lifting assembly configured to lift the cantilever arm up and down upon actuation, wherein the cantilevering arm raises and lowers the aerator assembly upon actuation of the lifting assembly; and
a shaft with wheels assembly attached, the shaft having a proximal end of the lift assembly attached to the shaft at least at one point between the wheels, the brace frame attached via the at least one lever linkage to the shaft-wheels assembly, wherein the shaft-wheels assembly lifts the aerator accessory as the lift assembly causes the wheels to move toward the aerator, thereby lifting the aerator accessory.

9. The lift system of claim 8 wherein the lift assembly comprises a hydraulic shaft or arm disposed within a hydraulic cylinder and a set of hydraulic tubes for controlling a vertical movement of the hydraulic shaft.

10. The lifting system of claim 8, wherein the lift assembly comprises a second lever linkage and an electric motor combination for actuating the cantilevering arm, wherein a proximal portion of the second lever linkage is coupled to the cantilevering arm and a distal portion of the second lever linkage is attached to the motor, the motor being mounted to the lower portion of the brace frame.

11. The lifting system of claim 8, wherein the aerator assembly is substituted for one of a de-thatcher mechanism, a plow, a bucket, and a snow blower.

12. The lifting system of claim 8, wherein the coupler member is one of a hitch, a metal loop or an eyelet, a clamp, and a hook.

13. The lifting system of claim 8 wherein the brace frame includes a third lever linkage coupled to the longitudinal frame and to the shaft-wheels assembly.
